(19) United States
(12) Patent Application Publication
(10) Pub. No.: US 2025/0013185 A1
(43) Pub. Date: Jan. 9, 2025

(54) IMAGE FORMING APPARATUS

(71) Applicant: FUJIFILM BUSINESS INNOVATION CORP., Tokyo (JP)

(72) Inventors: Riwako MIYAUCHI, Kanagawa (JP); Hiroyuki Kono, Kanagawa (JP); Keigo Shinoto, Kanagawa (JP); Hayato Inoue, Kanagawa (JP)

(73) Assignee: FUJIFILM BUSINESS INNOVATION CORP., Tokyo (JP)

(21) Appl. No.: 18/432,227

(22) Filed: Feb. 5, 2024

(30) Foreign Application Priority Data
Jul. 6, 2023 (JP) 2023-111222

(51) Int. Cl. G03G 21/16

(52) U.S. Cl. CPC G03G 21/1619; G03G 21/1642

(57) ABSTRACT

An image forming apparatus includes a frame that holds an image forming section and to which at least one substrate that bears a part of functions of the image forming section is attached, the frame being such that, at one side surface to which the at least one substrate is attached of the frame, a width in a vertical direction of a space portion formed between multiple longitudinal shape portions that extend in a horizontal direction between portions of the frame that extend in the vertical direction is larger than a width in the vertical direction of the longitudinal shape portions, in which the at least one substrate includes multiple substrates, at least a part of the multiple substrates are disposed so as to be connected between the portions of the frame that extend in the vertical direction, and, when the frame is divided into two regions by a central line in an imaginary manner in the horizontal direction, of the substrates that are connected, an uppermost substrate and a lowermost substrate in the vertical direction are disposed so as to be positioned at different ones of the two regions.

### CROSS-REFERENCE TO RELATED APPLICATIONS

This application is based on and claims priority under 35 USC 119 from Japanese Patent Application No. 2023-111222 filed Jul. 6, 2023.

### BACKGROUND

### (i) Technical Field

The present disclosure relates to an image forming apparatus.

### (ii) Related Art

For example, Japanese Unexamined Patent Application Publication No. 2005-31364 discloses a structure that is a base portion of an image-forming-apparatus structural body and that is provided with intermediate attaching members provided at frame base members serving as long sides of a rectangular frame, the base portion including the frame base members that form the rectangular frame by being respectively disposed on the front, rear, left, and right sides, attaching members that are disposed on the four corners of the rectangular frame and that connect the corresponding frame members in a front-rear direction and a left-right direction, and a bottom plate member. In the structure, multiple channel-shaped frame members are installed on the base portion to constitute the image-forming-apparatus structural body.

### SUMMARY

Here, a case in which a substrate is attached to one side surface of a frame of an image forming apparatus is considered. Here, at the one side surface of the frame to which the substrate is attached, a width in a vertical direction of a space portion formed between multiple longitudinal shape portions that extend in a horizontal direction between portions of the frame in the vertical direction may be made larger than a width in the vertical direction of the longitudinal shape portions to reduce the area of the frame and to thus reduce costs. However, such a structure may no longer be a structure that ensures the rigidity for operating the image forming apparatus.

Aspects of non-limiting embodiments of the present disclosure relate to ensuring the rigidity of an image forming apparatus even when, at one side surface of a frame to which a substrate is attached, a width in a vertical direction of a space portion formed between multiple longitudinal shape portions that extend in a horizontal direction between portions of the frame that extend in the vertical direction is larger than a width in the vertical direction of the longitudinal shape portions.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an image forming apparatus including a frame that holds an image forming section and to which at least one substrate that bears a part of functions of the image forming section is attached, the frame being such that, at one side surface to which the at least one substrate is attached of the frame, a width in a vertical direction of a space portion formed between multiple longitudinal shape portions that extend in a horizontal direction between portions of the frame that extend in the vertical direction is larger than a width in the vertical direction of the longitudinal shape portions, in which the at least one substrate includes multiple substrates, at least a part of the multiple substrates are disposed so as to be connected between the portions of the frame that extend in the vertical direction, and, when the frame is divided into two regions by a central line in an imaginary manner in the horizontal direction, of the substrates that are connected, an uppermost substrate and a lowermost substrate in the vertical direction are disposed so as to be positioned at different ones of the two regions.

### BRIEF DESCRIPTION OF THE DRAWINGS

An exemplary embodiment of the present disclosure will be described in detail based on the following figures, wherein:

FIG. 1 is a schematic structural view of an image forming apparatus to which an exemplary embodiment is applied;

FIG. 2 is a perspective view that illustrates a frame that holds an image forming section of the image forming apparatus;

FIG. 3 is a diagram that illustrates accommodating units that are attached to the frame;

FIGS. 4A to 4C are each a diagram that illustrates the frame when the accommodating units are attached or when the accommodating units are not attached, with FIG. 4A showing the frame serving as a model when the accommodating units are not attached, FIGS. 4B and 4C each showing an example of an attaching arrangement when the accommodating units are attached to the frame, and FIGS. 4B and 4C each showing a state of the frame when seen from a side surface side;

FIG. 5 is a graph showing the flatness of an AA plane (see FIG. 4A) when shifts are made at a measurement point B1 and at a measurement point B3 in a +Y direction in the examples of the respective attaching arrangements in FIGS. 4A to 4C, with the vertical axis indicating the flatness and the horizontal axis indicating a B1 displacement and a B3 displacement in the examples of the respective attaching arrangements in FIGS. 4A to 4C;

FIGS. 6A to 6C are each a diagram that illustrates a connection mode of connecting the accommodating units that are adjacent to each other, with FIG. 6A showing one connection mode, FIG. 6B showing another connection mode, and FIG. 6C being a graph in which the vertical axis indicates the flatness and the horizontal axis indicates the B1 displacement and the B3 displacement in FIGS. 6A and 6B;

FIGS. 7A to 7D are each a diagram that illustrates an external shape combination mode in which the external shapes of the accommodating units are changed, with FIG. 7A showing one external shape combination mode, FIG. 7B showing another external shape combination mode, FIG. 7C showing still another external shape combination mode, and FIG. 7D being a graph in which the vertical axis indicates the flatness and the horizontal axis indicates the B1 displacement and the B3 displacement in FIGS. 7A to 7C;

FIGS. 8A to 8D are each a diagram that illustrates a frame connection mode of connecting the accommodating units to the frame, with FIG. 8A showing one frame connection mode, FIG. 8B showing another frame connection mode, FIG. 8C showing still another frame connection mode, and FIG. 8D being a graph in which the vertical axis indicates the flatness and the horizontal axis indicates the B1 displacement and the B3 displacement in FIGS. 8A to 8C;

FIGS. 9A to 9D are each a diagram that illustrates a plate-thickness combination mode in which the plate thicknesses of the accommodating units are changed, and show various plate-thickness combination modes; and

FIG. 10 is a graph that shows the B1 displacement and the B3 displacement in FIGS. 9A to 9D.

### DETAILED DESCRIPTION

An exemplary embodiment of the present disclosure is described in detail below with reference to the attached drawings. Note that, for example, the size and the thickness of each portion in the drawings that are referred to in the description below may differ from the actual dimensions.

### Image Forming Apparatus 100

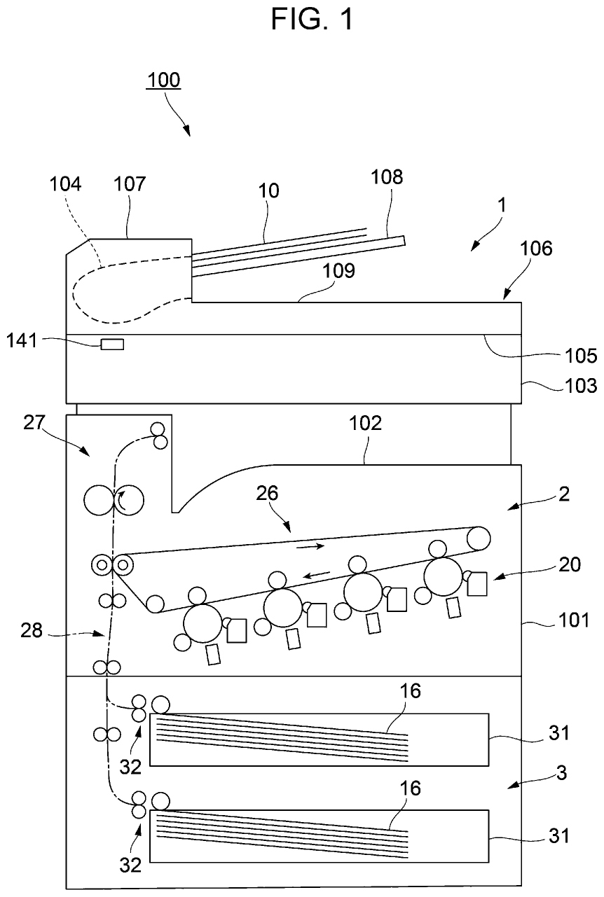

FIG. 1 is a schematic structural view of an image forming apparatus 100 to which the exemplary embodiment is applied.

As shown in FIG. 1, the image forming apparatus 100 includes an original reading device 1 that reads information of an original 10, an image forming section 2 that forms an image on a recording sheet 16 based on the information (read image) of the original read by the original reading device 1, and a sheet feeder 3 that sends out a recording sheet 16 to be supplied to the image forming section 2. In the image forming apparatus 100, the image forming section 2 and the sheet feeder 3 are accommodated inside a body 101, whereas the original reading device 1 is disposed above the body 101. An upper surface portion of the body 101 is provided with a discharge accommodating unit 102 to which the recording sheet 16 having the image formed thereon is discharged and that accommodates this recording sheet 16.

The original reading device 1 includes a housing 103. The original reading device 1 includes at an upper surface portion of the housing 103 a light transmissive original table 105 on which an original 10 is placed and an original cover 106 that covers the original table 105 and that is capable of being opened and closed with respect to the housing 103. The original cover 106 is provided with an automatic original transporting unit 107 that transports an original 10 up to a reading position and discharges the original 10 after the reading, an original tray 108 on which the original 10 that is sent by the automatic original transporting unit 107 is placed, and an accommodating unit 109 that accommodates the original 10 that is discharged from the automatic original transporting unit 107.

The image forming section 2 includes image forming units 20 that form toner images of respective colors, yellow (Y), magenta (M), cyan (C), and black (K) by, for example, an electrophotographic system, an intermediate transfer unit 26 that transports the toner images formed by the image forming units 20 until the toner images are transferred to a recording sheet 16, and a fixing unit 27 that fixes the toner images transferred to the recording sheet 16 from the intermediate transfer unit 26. In this way, the image forming section 2 has multiple functions, such as a developing function, a transfer function, and a fixing function.

The image forming section 2 is a printing mechanism that forms an image on a recording sheet 16. Here, the image forming section 2 is, for example, a printer, and may use an electrophotographic system that transfers toner adhered to a photoconductor to a recording sheet 16 and forms an image, or an inkjet system that discharges ink onto a recording sheet 16 and forms an image.

The sheet feeder 3 includes drawer-type accommodating members 31 that are capable of accommodating multiple recording sheets 16 of predetermined sizes, types, and the like, and sending-out devices 32 that send out one sheet at a time the recording sheets 16 accommodated in the accommodating members 31 to a transport path. A supply transport path 28 that allows the recording sheets 16 that have been sent out from the sheet feeder 3 to be transported up to a second transfer position is disposed between the sheet feeder 3 and the image forming section 2.

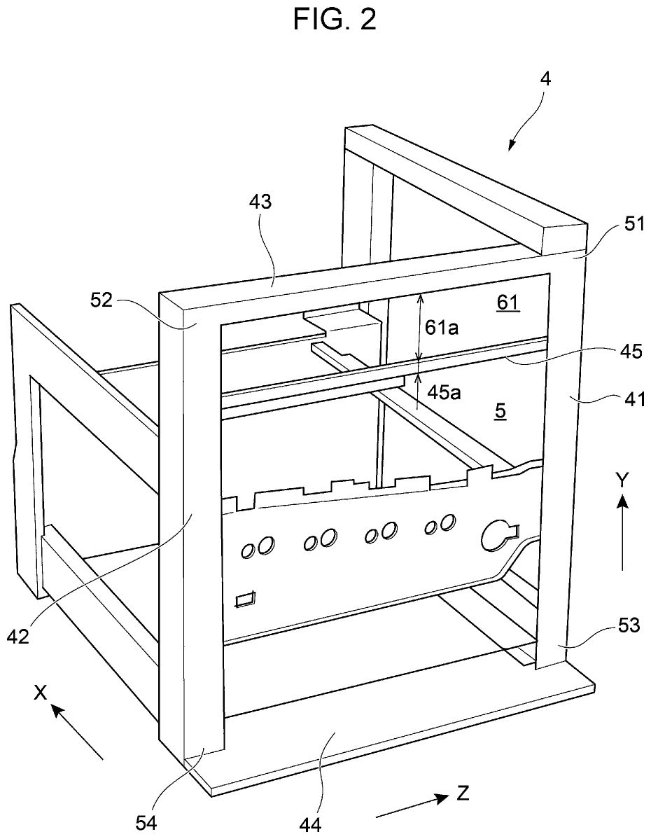

FIG. 2 is a perspective view that illustrates a frame 4 that holds the image forming section 2 of the image forming apparatus 100. The frame 4 constitutes a part of the body 101 above (see FIG. 1).

As shown in FIG. 2, the frame 4 includes height-direction portions 41 and 42 that extend in a Y direction or a longitudinal direction, and lateral-direction portions 43, 44, and 45 that extend in a Z direction or a lateral direction. The height-direction portions 41 and 42 and the lateral-direction portions 43, 44, and 45 form a side surface 5 of the frame 4. Note that the lateral-direction portion 45 may be attached with a screw instead of being attached by welding.

Focusing on a space 61 that is formed between the lateral-direction portions 43 and 45, a width 61a of the space 61 in the Y direction is larger than a width 45a of the lateral-direction portion 45. The space 61 is an example of a space portion.

Here, the “height direction” refers to an “up-down direction” or a “vertical direction” of the frame 4 when the image forming apparatus 100 is placed on a surface, such as a floor, and the “lateral direction” refers to a “left-right direction” or a “horizontal direction” of the frame 4 when the image forming apparatus 100 is placed on a surface, such as a floor.

To describe further, at the side surface 5, a corner 51 is formed by the height-direction portion 41 and the lateral-direction portion 43 and a corner 52 is formed by the height-direction portion 42 and the lateral-direction portion 43. A corner 53 is formed by the height-direction portion 41 and the lateral-direction portion 44 and a corner 54 is formed by the height-direction portion 42 and the lateral-direction portion 44.

The height-direction portions 41 and 42 are each an example of a portion of the frame that extends in the vertical direction, and the lateral-direction portions 43 to 45 are each an example of a longitudinal shape portion that extends in the horizontal direction. The side surface 5 is an example of one side surface.

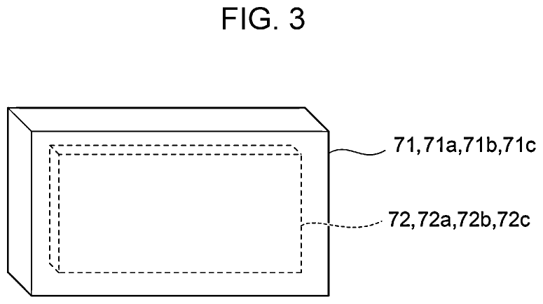

FIG. 3 is a diagram that illustrates accommodating units 71 that are attached to the frame 4.

Each accommodating unit 71 shown in FIG. 3 is a case that is attached to the frame 4, and accommodates a substrate 72 indicated by a broken line. Such a substrate 72 is, for example, a printed circuit board and bears at least a part of the aforementioned functions of the image forming section 2.

As a result of the substrates 72 being accommodated in the accommodating units 71 serving as shield cases, electromagnetic waves that are generated when the substrates 72 are electromagnetic-wave generating sources are not emitted to the outside, and the substrates 72 become resistant to the surrounding electromagnetic environment.

To describe further, multiple accommodating units 71 are attached to the side surface 5 of the frame 4. More specifically, at least a part of the multiple accommodating units 71 are disposed so as to be connected to the height-direction portions 41 and 42.

In the exemplary embodiment, although the substrates 72 are attached to the frame 4 so as to be accommodated in the accommodating units 71, it is not limited thereto, and the substrates 72 may be directly attached to the frame 4 without using the accommodating units 71. That is, a structure in which the substrates 72 are attached to the frame 4 includes, in addition to a structure in which the substrates 72 are directly attached to the frame 4, a structure in which the substrates 72 are attached to the frame 4 so as to be accommodated in the accommodating units 71.

Hereunder, as an example of attachment of the substrates 72 to the frame 4, the case in which the substrates 72 are accommodated in the accommodating units 71 is described and the case in which the substrates 72 are directly attached is not described, though this can be similarly performed.

When there are multiple accommodating units 71, the accommodating units 71 are distinguished as, for example, accommodating units 71a, 71b, and 71c, and substrates 72a to 72c are accommodated in the respective accommodating units 71a to 71c. Such substrates 72a to 72c may be formed as one substrate or may be disposed as multiple substrates so as to be, for example, stacked in two layers. Alternatively, such substrates 72a to 72c may be disposed sideways as multiple substrates in a plane.

Next, how flatness is affected by whether or not accommodating units 71 are attached and by an example of an attaching arrangement is described. Here, the “flatness” refers to a magnitude indicating a flatness degree of a certain surface.

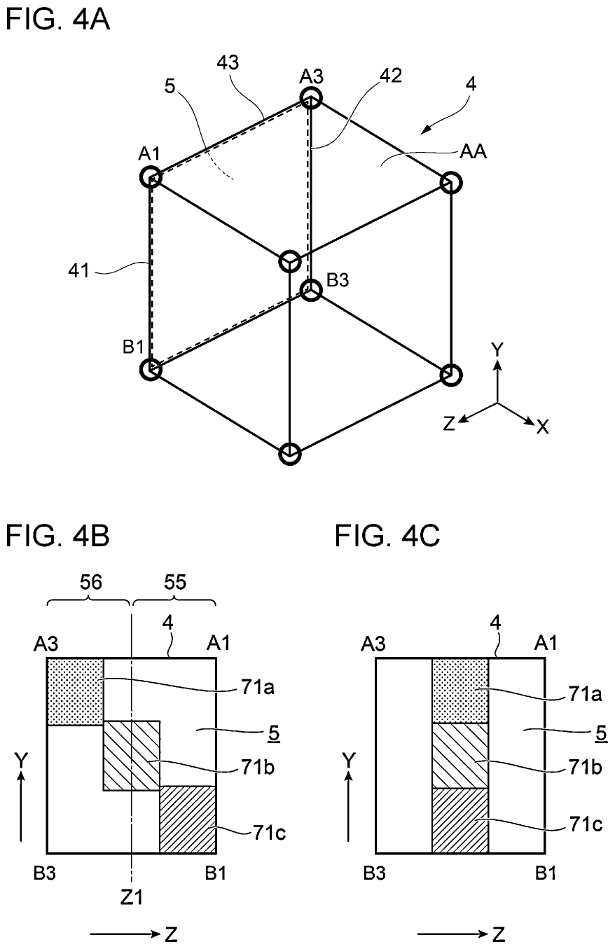

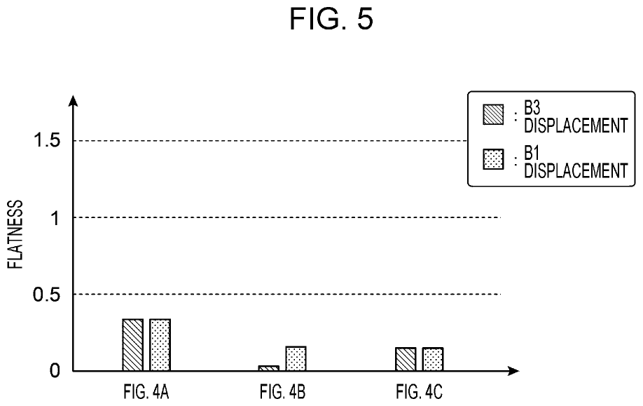

FIGS. 4A to 4C are each a diagram that illustrates the frame 4 when the accommodating units 71 are attached or when the accommodating units 71 are not attached, with FIG. 4A showing the frame 4 serving as a model when the accommodating units 71 are not attached, FIGS. 4B and 4C each showing an example of an attaching arrangement when the accommodating units 71 are attached to the frame 4. FIGS. 4B and 4C each shows a state of the frame 4 when seen from a side-surface-5 side. Note that an AA plane shown in FIG. 4A is an XZ plane including measurement points A1 and A3, and is used when describing, for example, FIG. 5 below.

As shown in FIG. 4A, in the frame 4 serving as a model, the accommodating units 71 (see FIG. 3) are not attached to the side surface 5. As described above, the side surface 5 is constituted by the height-direction portions 41 and 42 and the lateral-direction portions 43 and 44.

A measurement point B1 shown in FIG. 4A corresponds to the aforementioned corner 53 (see FIG. 2). A measurement point B3 and the measurement points A1 and A3 correspond to the respective corners 54, 51, and 52 mentioned above (see the same figure).

In the example of the attaching arrangement shown in FIG. 4B, the accommodating units 71a, 71b, and 71c are obliquely arranged on the side surface 5 of the frame 4. That is, the accommodating unit 71a is disposed at the measurement point A3, the accommodating unit 71c is disposed at the measurement point B1, and the accommodating unit 71b is disposed between the accommodating unit 71a and the accommodating unit 71c. The accommodating unit 71b is connected to the accommodating units 71a and 71c.

To describe further, in the example of the attaching arrangement shown in FIG. 4B, the accommodating unit 71b is disposed so as to include an imaginary central line Z1 that is a central line of the imaginary frame 4 in the horizontal direction, that is, the Z direction.

In the example of the attaching arrangement shown in FIG. 4B, when the frame 4 is divided by the imaginary central line Z1 into two regions 55 and 56, the accommodating unit 71a that is an uppermost accommodating unit and the accommodating unit 71c that is a lowermost accommodating unit are positioned in different ones of the two regions. That is, the accommodating unit 71a is disposed so as to be positioned at the region 56 and the accommodating unit 71c is disposed so as to be positioned at the region 55; and, in the example of attachment shown in FIG. 4B, the accommodating units 71a to 71c are arranged so as to form an oblique line.

Note that, in the example of the attaching arrangement shown in FIG. 4B, the accommodating units 71a to 71c are not disposed symmetrically on the side surface 5 in the left-right direction.

The accommodating unit 71a in FIG. 4B is an example of a first substrate, the accommodating unit 71b in FIG. 4B is an example of a third substrate, and the accommodating unit 71c in FIG. 4B is an example of a second substrate.

In the example of the attaching arrangement shown in FIG. 4C, although the accommodating units 71a, 71b, and 71c are arranged as in the case of FIG. 4B, they are not obliquely arranged. That is, the accommodating units 71a to 71c are arranged in the height direction side by side in the center in the Z direction. More specifically, the accommodating unit 71a is the uppermost accommodating unit, the accommodating unit 71c is the lowermost accommodating unit, and the accommodating unit 71b is connected to the accommodating units 71a and 71c.

FIG. 5 is a graph showing the flatness of the AA plane (see FIG. 4A) when shifts are made at the measurement point B1 and the measurement point B3 in a +Y direction in the examples of the respective attaching arrangements in FIGS. 4A to 4C, with the vertical axis indicating the flatness and the horizontal axis indicating a B1 displacement and a B3 displacement in the examples of the respective attaching arrangements in FIGS. 4A to 4C. Note that the B1 displacement and the B3 displacement are simulation results when shifts of 10 mm in the Y direction are forcefully made at the measurement points B1 and B3.

In the graph of FIG. 5, the smaller the values of the flatness are, the better the results are. When the flatnesses of the examples of the respective attaching arrangements shown in FIGS. 4A to 4C are compared, the example of the attaching arrangement shown in FIG. 4A has the largest values for the B1 displacement and the B3 displacement. The example of the attaching arrangement shown in FIG. 4B and the example of the attaching arrangement shown in FIG. 4C have a B1 displacement value and a B3 displacement value that are both smaller than those of the example of the attaching arrangement shown in FIG. 4A.

In the graph of FIG. 5, when the example of the attaching arrangement shown in FIG. 4B and the example of the attaching arrangement shown in FIG. 4C are compared to each other, the value of the B3 displacement of the example of the attaching arrangement shown in FIG. 4B is smaller than the value of the B3 displacement of the example of the attaching arrangement shown in FIG. 4C.

On the other hand, the value of the B1 displacement of the example of the attaching arrangement shown in FIG. 4B and the value of the B1 displacement of the example of the attaching arrangement shown in FIG. 4C are substantially the same.

In this way, focusing on the B3 displacement, the effect with respect to the forceful displacement of 10 mm in the Y direction is smaller for the example of the attaching arrangement shown in FIG. 4B than for the examples of the attaching arrangements shown in FIGS. 4A and 4C. Therefore, when the accommodating units 71a to 71c are to be provided on the side surface 5, the effect with respect to the forceful displacement of 10 mm in the Y direction at the measurement points B1 and B3 is suppressed, and, further, when the accommodating units 71a to 71c are to be arranged on the side surface 5 in the form of a diagonal line connecting the measurement points A3 and B1, the effect at the measurement point B3 is further suppressed compared to when the accommodating units 71a to 71c are arranged in a straight line.

For example, when there is a measurement point where the effect with respect to the forceful displacement of 10 mm in the Y direction is to be suppressed (for example, the measurement point B3), this can be realized by arranging multiple measurement points other than such a measurement point in the form of a diagonal line.

Next, other possible modes of oblique arrangement of the accommodating units 71a to 71c shown in FIG. 4B above are described. More specifically, connection modes of connecting the accommodating units 71a and 71c to each other, external shape combination modes in which the external shapes of the accommodating units 71a to 71c are changed, frame connection modes of connecting the accommodating units 71a to 71c to the frame 4, and plate-thickness combination modes in which the plate thicknesses of the accommodating units 71a to 71c are changed are described.

Note that, in addition to using any one of a connection mode, an external shape combination mode, a frame connection mode, and a plate-thickness combination mode, any two or more of a connection mode, an external shape combination mode, a frame connection mode, and a plate-thickness combination mode may be used.

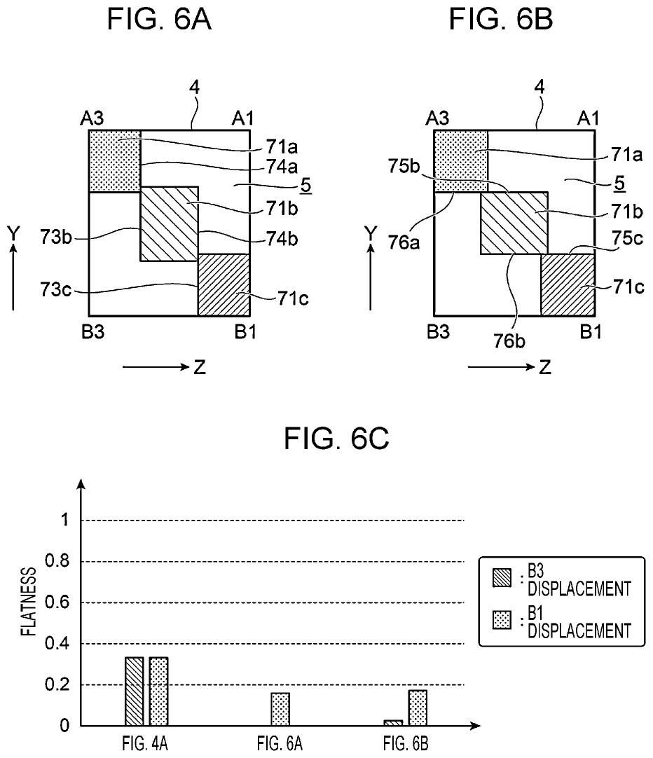

FIGS. 6A to 6C are each a diagram that illustrates a connection mode of connecting the accommodating units 71a to 71c that are adjacent to each other, with FIG. 6A showing one connection mode, FIG. 6B showing another connection mode, and FIG. 6C being a graph in which the vertical axis indicates the flatness and the horizontal axis indicates the B1 displacement and the B3 displacement in FIGS. 6A and 6B. Note that, in the graph of FIG. 6C, the case of FIG. 4A is used for comparison.

In the one connection mode shown in FIG. 6A, the accommodating units 71a to 71c that are adjacent to each other are connected to each other at surfaces thereof extending in the Y direction. That is, a surface 74a of the accommodating unit 71a and a surface 73b of the accommodating unit 71b are connected to each other, and a surface 74b of the accommodating unit 71b and a surface 73c of the accommodating unit 71c are connected to each other. In other words, the one connection mode shown in FIG. 6A is a mode in which the connection between the accommodating units is in the lateral direction, and the multiple accommodating units are connected to each other in the horizontal direction. Note that, as described above, when multiple substrates are to be attached to the side surface 5 without using multiple accommodating units, the multiple substrates may be horizontally connected to each other.

In the other connection mode shown in FIG. 6B, the accommodating units 71a to 71c that are adjacent to each other are connected to each other at surfaces thereof extending in the Z direction. That is, a surface 76a of the accommodating unit 71a and a surface 75b of the accommodating unit 71b are connected to each other, and a surface 76b of the accommodating unit 71b and a surface 75c of the accommodating unit 71c are connected to each other. In other words, the other connection mode shown in FIG. 6B is a mode in which the connection between the accommodating units is in the height direction.

In the graph of FIG. 6C, focusing on the B3 displacement, when the connection modes of FIGS. 6A and 6B are compared, the value for the connection mode shown in FIG. 6A is smaller than the value for the connection mode shown in FIG. 6B.

More specifically, although the B3 displacement for the connection mode shown in FIG. 6B is smaller than the B3 displacement for the connection mode shown in FIG. 4A, there is substantially no B3 displacement for the connection mode shown in FIG. 6A.

Accordingly, focusing on the B3 displacement, in the case of the connection mode shown in FIG. 6A, that is, when the connection between the accommodating units is in the lateral direction instead of in the height direction, it is possible to eliminate the effect with respect to the forceful displacement of 10 mm in the Y direction. Therefore, as the connection mode of connecting the accommodating units 71a to 71c that are adjacent to each other, it is desirable that the Y-direction surfaces be connected from the viewpoint of the flatness at the measurement point B3.

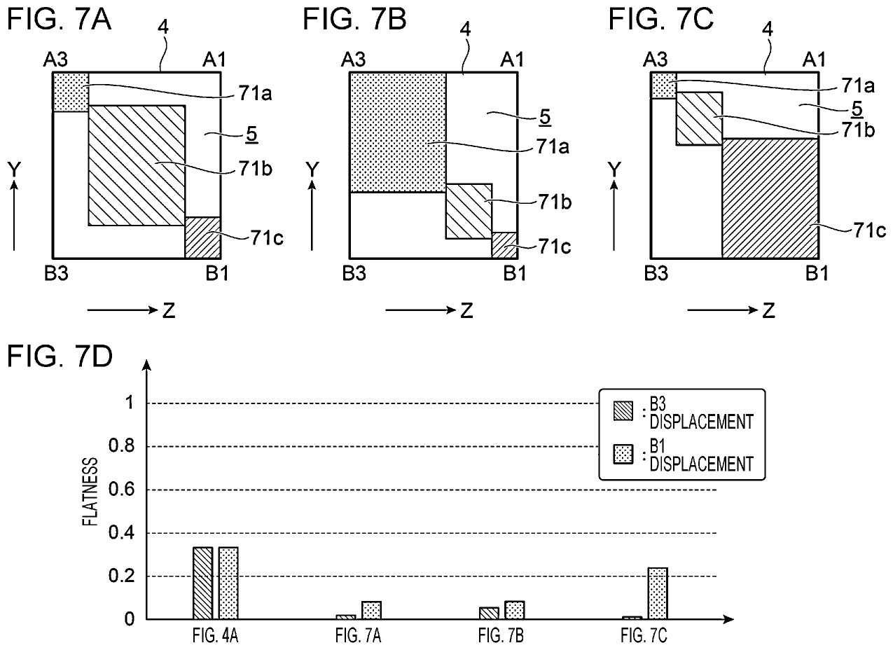

FIGS. 7A to 7D are each a diagram that illustrates an external shape combination mode in which the external shapes of the accommodating units 71a to 71c are changed, with FIG. 7A showing one external shape combination mode, FIG. 7B showing another external shape combination mode, FIG. 7C showing still another external shape combination mode, and FIG. 7D being a graph in which the vertical axis indicates the flatness and the horizontal axis indicates the B1 displacement and the B3 displacement in FIGS. 7A to 7C. Note that, in the graph of FIG. 7D, the case of FIG. 4A is used for comparison.

In the one external shape combination mode shown in FIG. 7A, of the accommodating units 71a to 71c, the accommodating unit 71b has an external shape that is larger than the external shapes of the accommodating units 71a and 71c. The external shapes of the accommodating units 71a and 71c have the same size. In the one external shape combination mode shown in FIG. 7A, the accommodating unit 71b whose external shape is larger is positioned at an intermediate location in a side-by-side arrangement of the accommodating units 71a to 71c.

In the other external shape combination mode shown in FIG. 7B, of the accommodating units 71a to 71c, the accommodating unit 71a has an external shape that is larger than the external shapes of the accommodating units 71b and 71c, and the external shape of the accommodating unit 71b is larger than the external shape of the accommodating unit 71c. That is, the external shapes of the accommodating units 71a to 71c have different sizes. The accommodating unit 71a that is attached to the location of the measurement point A3 is the largest, and the accommodating unit 71c that is attached to the location of the measurement point B1 is the smallest. In the other external shape combination mode shown in FIG. 7B, the accommodating unit 71a whose external shape is larger is disposed on the upper side.

In the still another external shape combination mode shown in FIG. 7C, of the accommodating units 71a to 71c, the accommodating unit 71c has an external shape that is larger than the external shapes of the accommodating units 71a and 71b, and the external shape of the accommodating unit 71b is larger than the external shape of the accommodating unit 71a.

Accordingly, the external shapes of the accommodating units 71a to 71c have different sizes as in the case of FIG. 7B. The accommodating unit 71c that is attached to the location of the measurement point B1 is the largest, and the accommodating unit 71a that is attached to the location of the measurement point A3 is the smallest. In the still another external shape combination mode shown in FIG. 7C, the accommodating unit 71c whose external shape is large is disposed on the lower side.

Note that the external shapes of the accommodating units 71a to 71c have sizes that correspond to those of the substrates 72a to 72c (see FIG. 3), and, for example, when the external shape of the accommodating unit 71a is larger than the external shapes of the other accommodating units 71b and 71c, the external shape of the substrate 72a that is accommodated in the accommodating unit 71a is larger than the external shapes of the other substrates 72b and 72c.

In addition, as described above, in addition to attaching the substrates 72a to 72c to the frame 4 by using the respective accommodating units 71a to 71c, the substrates 72a to 72c may be directly attached to the frame 4.

In the graph shown in FIG. 7D, focusing not only on the B3 displacement but also on the B1 displacement, the connection modes of FIGS. 7A, 7B, and 7C are compared. Although the connection mode having the smallest B3 displacement is the connection mode shown in FIG. 7C, the connection mode shown in FIG. 7C has the largest B1 displacement. Therefore, from the viewpoint of flatness, the connection mode shown in FIG. 7A and whose B3 displacement is small and the connection mode shown in FIG. 7B are desirable.

Therefore, when the external shapes of the accommodating units 71a to 71c differ from each other, of the accommodating units 71a to 71c, it is desirable that the accommodating unit whose external shape is large be disposed on the upper side (Y direction).

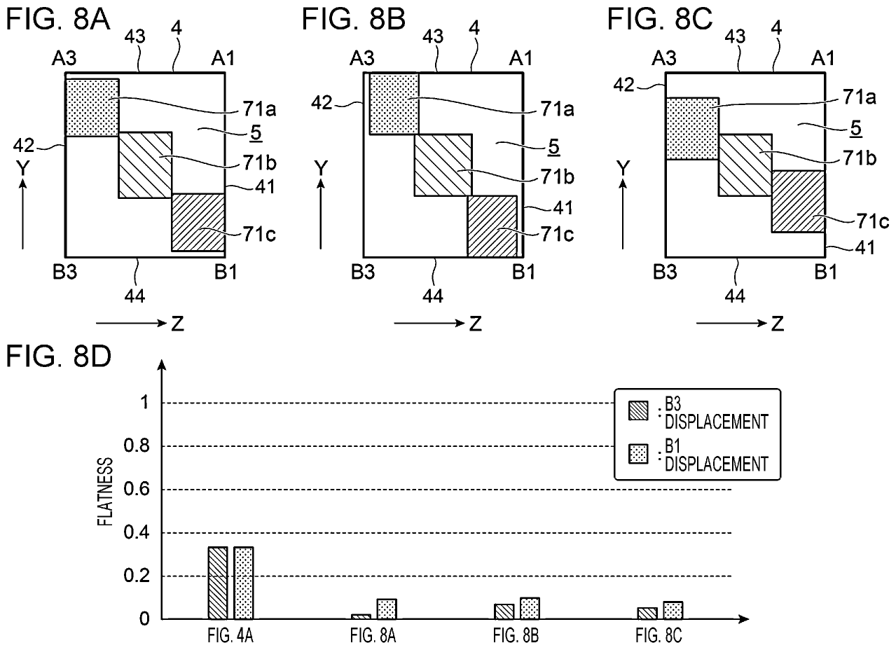

FIGS. 8A to 8D are each a diagram that illustrates a frame connection mode of connecting the accommodating units 71a to 71c to the frame 4, with FIG. 8A showing one frame connection mode, FIG. 8B showing another frame connection mode, FIG. 8C showing still another frame connection mode, and FIG. 8D being a graph in which the vertical axis indicates the flatness and the horizontal axis indicates the B1 displacement and the B3 displacement in FIGS. 8A to 8C. Note that, in the graph of FIG. 8D, the case of FIG. 4A is used for comparison.

In the one frame connection mode shown in FIG. 8A, the accommodating unit 71a is connected to the height-direction portion 42, but is not connected to the lateral-direction portion 43. The accommodating unit 71c is connected to the height-direction portion 41, but is not connected to the lateral-direction portion 44.

In the other frame connection mode shown in FIG. 8B, the accommodating unit 71a is connected to the lateral-direction portion 43, but is not connected to the height-direction portion 42. The accommodating unit 71c is connected to the lateral-direction portion 44, but is not connected to the height-direction portion 41.

In the still another frame connection mode shown in FIG. 8C, as in the frame connection mode shown in FIG. 8A, the accommodating unit 71a is connected to the height-direction portion 42, but is not connected to the lateral-direction portion 43; and the accommodating unit 71c is connected to the height-direction portion 41, but is not connected to the lateral-direction portion 44.

To describe further, in the still another frame connection mode shown in FIG. 8C, the position where the accommodating unit 71a is connected to the height-direction portion 42 is below that in the frame connection mode shown in FIG. 8A and is situated away from the lateral-direction portion 43. The position where the accommodating unit 71c is connected to the height-direction portion 41 is above that in the frame connection mode shown in FIG. 8A and is situated away from the lateral-direction portion 44.

In this way, in the frame connection modes shown in FIGS. 8A to 8C, the uppermost accommodating unit 71a and the lowermost accommodating unit 71c are connected to either one of a set of the height-direction portions 41 and 42 that extend in the vertical direction and a set of the lateral-direction portions 43 and 44 that extend in the horizontal direction, and are not connected to the other of the set of the height-direction portions 41 and 42 that extend in the vertical direction and the set of the lateral-direction portions 43 and 44 that extend in the horizontal direction (see FIGS. 8A to 8C).

The accommodating units 71a and 71c in the frame connection modes shown in FIGS. 8A and 8C are connected to the set of the height-direction portions 41 and 42, but are not connected to the set of the lateral-direction portions 43 and 44.

Note that, as mentioned above, the substrates 72a to 72c (see FIG. 3) may be directly attached to the frame 4 instead of being accommodated in the accommodating units 71a to 71c. In such a case, “the accommodating unit 71a”, “the accommodating unit 71b”, and “the accommodating unit 71c” described above in this paragraph are replaced by “the substrate 72a”, “the substrate 72b”, and “the substrate 72c”.

Focusing on the B3 displacement of the graph shown in FIG. 8D, the value for the frame connection mode shown in FIG. 8A is the smallest, and the values increase in the order of the value for the frame connection mode shown in FIG. 8C and the value for the frame connection mode shown in FIG. 8B.

Focusing on the B1 displacement of the graph, the value for the frame connection mode shown in FIG. 8C is the smallest, and the values increase in the order of the value for the frame connection mode shown in FIG. 8A and the value for the frame connection mode shown in FIG. 8B.

Therefore, focusing on, not only the B3 displacement, but also the B1 displacement, the frame connection mode in which the accommodating unit 71a is connected to the height-direction portion 42 and the accommodating unit 71c is connected to the height-direction portion 41 is desirable.

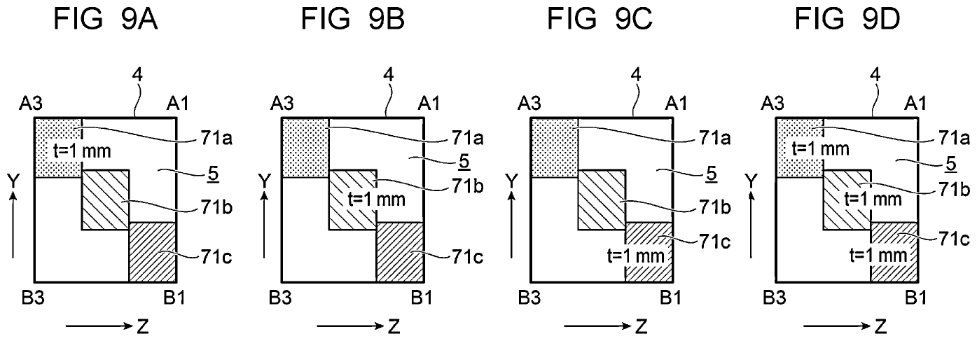

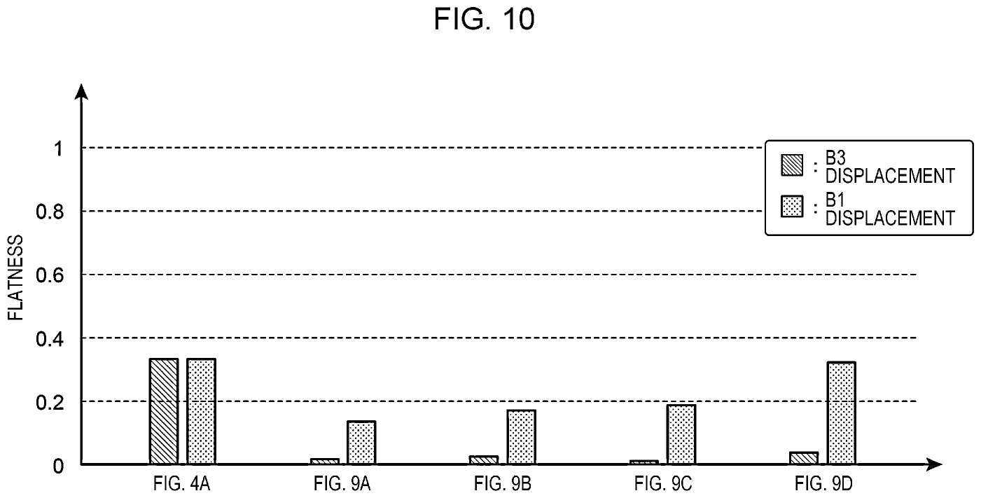

FIGS. 9A to 9D are each a diagram that illustrates a plate-thickness combination mode in which the plate thicknesses of the accommodating units 71a to 71c are changed, and show various plate-thickness combination modes. FIG. 10 is a graph that shows the B1 displacement and the B3 displacement in FIGS. 9A to 9D. Note that, in the graph of FIG. 10, the case of FIG. 4A is used for comparison. Note that, in the plate-thickness combination modes, the accommodating unit 71a is an example of a first accommodating unit, the accommodating unit 71b is an example of a third accommodating unit, and the accommodating unit 71c is an example of a second accommodating unit.

In the plate-thickness combination mode shown in FIG. 9A, of the accommodating units 71a to 71c, the accommodating unit 71a has a plate thickness t that is 1 mm, which is the same as that of the frame 4, and the other accommodating units 71b and 71c have plate thicknesses t that are 0.6 mm, which is less than that of the frame 4. In such a case, the accommodating units 71b and 71c are examples of thin-plate accommodating units.

In the plate-thickness combination mode shown in FIG. 9B, the accommodating unit 71b has a plate thickness t that is 1 mm, and the other accommodating units 71a and 71c have plate thicknesses t that are 0.6 mm. In such a case, the accommodating units 71a and 71c are examples of thin-plate accommodating units.

In the plate-thickness combination mode shown in FIG. 9C, the accommodating unit 71c has a plate thickness t that is 1 mm, and the other accommodating units 71a and 71b have plate thicknesses t that are 0.6 mm. In such a case, the accommodating units 71a and 71b are examples of thin-plate accommodating units.

In this way, in FIGS. 9A to 9C, the plate thickness t of one of the accommodating units 71a to 71c is 1 mm, and the plate thicknesses t of the other accommodating units are 0.6 mm.

In the plate-thickness combination mode shown in FIG. 9D, the plate thicknesses t of all of the accommodating units 71a to 71c are 1 mm.

In the graph shown in FIG. 10, focusing on the B3 displacement, the value of the B3 displacement for the plate-thickness combination mode shown in FIG. 9C is substantially 0. The values of the B3 displacement increase in the order of the value for the plate-thickness combination mode shown in FIG. 9A, the value for the plate-thickness combination mode shown in FIG. 9B, and the value for the plate-thickness combination mode shown in FIG. 9D.

In the graph shown in FIG. 10, focusing on the B1 displacement, the value of the B1 displacement for the plate-thickness combination mode shown in FIG. 9A is the smallest, and the values increase in the order of the value for the plate-thickness combination mode shown in FIG. 9B, the value for the plate-thickness combination mode shown in FIG. 9C, and the value for the plate-thickness combination mode shown in FIG. 9D.

To describe further, focusing on both the B3 displacement and the B1 displacement, the most desirable mode is the plate-thickness combination mode shown in FIG. 9A. The next desirable mode is the plate-thickness combination mode shown in FIG. 9C. The next desirable modes are the plate-thickness combination mode shown in FIG. 9B and the plate-thickness combination mode shown in FIG. 9D. That is, the larger the plate thickness t is, the poorer the flatness is. Therefore, in the plate-thickness combination modes, it is desirable that the plate thickness t of one of the accommodating units 71a to 71c be smaller than the thickness of the frame 4.

Here, the frame 4 shown in FIG. 2 is described.

At the side surface 5 to which the accommodating units 71a to 71c are attached of the frame 4 (see, for example, FIG. 4B), the proportion of the area of the frame 4 with respect to the entire area of the side surface 5 is ⅔ or less. In the case of such a proportion, reinforcement by attaching the substrates 72a to 72c to the side surface 5 by using the accommodating units 71a to 71c becomes more meaningful. Note that this also applies when the substrates 72a to 72c are directly attached to the side surface 5.

The entire area of the side surface 5 here includes the area of a region surrounded by the height-direction portions 41 and 42 and the lateral-direction portions 43 and 44 and the areas of the height-direction portions 41 and 42 and the lateral-direction portions 43 and 44 at the side surface 5. The area of the frame 4 is the area obtained by subtracting the area of the space 61 of the side surface 5 and the area of a cutout or the like from the entire area of the side surface 5.

The foregoing description of the exemplary embodiments of the present disclosure has been provided for the purposes of illustration and description. It is not intended to be exhaustive or to limit the present disclosure to the precise forms disclosed. Obviously, many modifications and variations will be apparent to practitioners skilled in the art. The embodiments were chosen and described in order to best explain the principles of the present disclosure and its practical applications, thereby enabling others skilled in the art to understand the present disclosure for various embodiments and with the various modifications as are suited to the particular use contemplated. It is intended that the scope of the present disclosure be defined by the following claims and their equivalents.

### APPENDIX

(((1)))

An image forming apparatus comprising:
a frame that holds an image forming section and to which at least one substrate that bears a part of functions of the image forming section is attached, the frame being such that, at one side surface to which the at least one substrate is attached of the frame, a width in a vertical direction of a space portion formed between a plurality of longitudinal shape portions that extend in a horizontal direction between portions of the frame that extend in the vertical direction is larger than a width in the vertical direction of the longitudinal shape portions,
wherein the at least one substrate includes a plurality of substrates, at least a part of the plurality of substrates are disposed so as to be connected between the portions of the frame that extend in the vertical direction, and, when the frame is divided into two regions by a central line in an imaginary manner in the horizontal direction, of the substrates that are connected, an uppermost substrate and a lowermost substrate in the vertical direction are disposed so as to be positioned at different ones of the two regions.

(((2)))

The image forming apparatus according to (((1))),
wherein the plurality of substrates are connected to each other in the horizontal direction.

(((3)))

The image forming apparatus according to (((1))) or (((2))),
wherein the plurality of substrates include a first substrate that is the uppermost substrate, a second substrate that is the lowermost substrate, and a third substrate that is positioned between the first substrate and the second substrate in the vertical direction, and wherein an external shape of the first substrate or an external shape of the third substrate is larger than an external shape of the second substrate.

(((4)))

The image forming apparatus according to (((3))),
wherein the external shape of the first substrate is larger than the external shape of the third substrate.

(((5)))

The image forming apparatus according to any one of (((1))) to ((4))),
wherein the uppermost substrate and the lowermost substrate are attached in a mode in which the uppermost substrate and the lowermost substrate are connected to either one of a set of the portions of the frame that extend in the vertical direction and a set of the longitudinal shape portions that extend in the horizontal direction, and are not connected to another of the set of the portions of the frame that extend in the vertical direction and the set of the longitudinal shape portions that extend in the horizontal direction.

(((6)))

The image forming apparatus according to (((5))),
wherein the mode is a mode in which the uppermost substrate and the lowermost substrate are connected to the set of the portions of the frame that extend in the vertical direction and are not connected to the set of the longitudinal shape portions that extend in the horizontal direction.

(((7)))

The image forming apparatus according to (((1))),
wherein when a first substrate that is the uppermost substrate is attached to the one side surface by a first accommodating unit, a second substrate that is the lowermost substrate is attached to the one side surface by a second accommodating unit, and a third substrate that is positioned between the first substrate and the second substrate in the vertical direction is attached to the one side surface by a third accommodating unit,
any of the first accommodating unit, the second accommodating unit, and the third accommodating unit is a thin-plate accommodating unit whose plate thickness is smaller than a plate thickness of the frame.

(((8))

The image forming apparatus according to (((7))),
wherein the third accommodating unit is the thin-plate accommodating unit.

(((9)))

The image forming apparatus according to (((8))),
wherein the second accommodating unit and the third accommodating unit are each the thin-plate accommodating unit.

(((10)))

The image forming apparatus according to (((1))),
wherein the frame is such that, at the one side surface to which the substrates are attached, a proportion of an area of the frame with respect to an entire area of the one side surface is ⅔ or less.

What is claimed is:

1. An image forming apparatus comprising:
a frame that holds an image forming section and to which at least one substrate that bears a part of functions of the image forming section is attached, the frame being such that, at one side surface to which the at least one substrate is attached of the frame, a width in a vertical direction of a space portion formed between a plurality of longitudinal shape portions that extend in a horizontal direction between portions of the frame that extend in the vertical direction is larger than a width in the vertical direction of the longitudinal shape portions,
wherein the at least one substrate includes a plurality of substrates, at least a part of the plurality of substrates are disposed so as to be connected between the portions of the frame that extend in the vertical direction, and, when the frame is divided into two regions by a central line in an imaginary manner in the horizontal direction, of the substrates that are connected, an uppermost substrate and a lowermost substrate in the vertical direction are disposed so as to be positioned at different ones of the two regions.

2. The image forming apparatus according to claim 1,
wherein the plurality of substrates are connected to each other in the horizontal direction.

3. The image forming apparatus according to claim 1,
wherein the plurality of substrates include a first substrate that is the uppermost substrate, a second substrate that is the lowermost substrate, and a third substrate that is positioned between the first substrate and the second substrate in the vertical direction, and
wherein an external shape of the first substrate or an external shape of the third substrate is larger than an external shape of the second substrate.

4. The image forming apparatus according to claim 3,
wherein the external shape of the first substrate is larger than the external shape of the third substrate.

5. The image forming apparatus according to claim 1,
wherein the uppermost substrate and the lowermost substrate are attached in a mode in which the uppermost substrate and the lowermost substrate are connected to either one of a set of the portions of the frame that extend in the vertical direction and a set of the longitudinal shape portions that extend in the horizontal direction, and are not connected to another of the set of the portions of the frame that extend in the vertical direction and the set of the longitudinal shape portions that extend in the horizontal direction.

6. The image forming apparatus according to claim 5,
wherein the mode is a mode in which the uppermost substrate and the lowermost substrate are connected to the set of the portions of the frame that extend in the vertical direction and are not connected to the set of the longitudinal shape portions that extend in the horizontal direction.

7. The image forming apparatus according to claim 1,
wherein when a first substrate that is the uppermost substrate is attached to the one side surface by a first accommodating unit, a second substrate that is the lowermost substrate is attached to the one side surface by a second accommodating unit, and a third substrate that is positioned between the first substrate and the second substrate in the vertical direction is attached to the one side surface by a third accommodating unit,
any of the first accommodating unit, the second accommodating unit, and the third accommodating unit is a thin-plate accommodating unit whose plate thickness is smaller than a plate thickness of the frame.

8. The image forming apparatus according to claim 7,
wherein the third accommodating unit is the thin-plate accommodating unit.

9. The image forming apparatus according to claim 8,
wherein the second accommodating unit and the third accommodating unit are each the thin-plate accommodating unit.

10. The image forming apparatus according to claim 1,
wherein the frame is such that, at the one side surface to which the substrates are attached, a proportion of an area of the frame with respect to an entire area of the one side surface is ⅔ or less.
